(19) United States
(12) Patent Application Publication
(10) Pub. No.: US 2015/0084935 A1
(43) Pub. Date: Mar. 26, 2015

(54) ELECTROMAGNETIC AND CAPACITIVE POINTER

(71) Applicant: WALTOP INTERNATIONAL CORPORATION, Hsinchu City (TW)

(72) Inventor: CHIEN-CHIA LIEN, Hsinchu City (TW)

(73) Assignee: WALTOP INTERNATIONAL CORPORATION, Hsinchu City (TW)

(21) Appl. No.: 14/242,096

(22) Filed: Apr. 1, 2014

(30) Foreign Application Priority Data
Sep. 25, 2013 (TW) 102134629

(51) Int. Cl. G06F 3/0354

(52) U.S. Cl. CPC G06F 3/03545
USPC 345/179

(57) ABSTRACT

An electromagnetic and capacitive pointer is disclosed. The electromagnetic and capacitive pointer comprises a tube assembly and a conductive tube assembly, a first and a second ferrite cores, an non-magnetic and conductive pin, a control circuit board, a conductive pin holder and a holder. The non-magnetic and conductive pin, the conductive pin holder, the holder, the control circuit board and the conductive tube assembly constitute a conductive path.

### FIELD OF THE INVENTION

The present invention relates to a pointer, and more particularly to an electromagnetic and capacitive pointer.

### DESCRIPTION OF THE PRIOR ART

Electromagnetic-type input technology applies electromagnetic pens and the input device with induction sensor coils. Electromagnetic pen has advantages of convenient for writing, tip pressure level function, and certain sensing height. Although electromagnetic type input technology has advantages of convenient for writing, tip pressure level function, and certain sensing height as mentioned above, an user's finger(s) or other touch sources will not work and a particular stylus must be used for input operation. Capacitive touch input technology has been widely applied in touch panel. Capacitive touch input technology has advantages of allowing the use of variety of touch sources such as an user's finger(s) for input operation and multi-touch gestures for various operations and functions. Various applications can be assigned corresponding to multi-touch gestures. Thus integrating both electromagnetic and capacitive input technologies into a touch panel will have both advantages thereof and significantly increase convenience of use.

The trend of development of touch panel is toward light weight, thin thickness and low production cost. Conventional arrangement of placing an electromagnetic induction substrate beneath a touch panel has the advantage of not affecting optical characteristics of the touch panel but also has disadvantages of increase weight and cost and alignment problem between a display panel and an electromagnetic induction substrate during manufacture processes.

In order to save costs, new technologies directly omit the substrate for supporting electromagnetic induction sensor coils and form electromagnetic induction sensor coils on a peripheral area of a sensor layer of a touch panel. Furthermore, in order to perform input operation on a touch panel with electromagnetic and capacitive input functions, a pointer with electromagnetic and capacitive functions must be used. The invention provides an electromagnetic and capacitive pointer to meet the requirement of using a pointer on a touch panel with electromagnetic and capacitive input functions.

### SUMMARY OF THE INVENTION

An object of the present invention is to provide an electromagnetic and capacitive pointer with both electromagnetic and user hand held capacitive input functions to meet the requirement of using a pointer on a touch panel with electromagnetic and capacitive input functions.

According to the object, one embodiment of the present invention provides an electromagnetic and capacitive pointer comprising a tube assembly and a conductive tube assembly, a first ferrite core and a second ferrite core, an non-magnetic and conductive pin penetrating through the first ferrite core and the second ferrite core and being moveable through the first ferrite core, a control circuit board connecting a coil winding the first ferrite core to form a resonance circuit, a conductive pin holder, the second ferrite core and one end of the non-magnetic and conductive pin being sheathed in the conductive pin holder, and a holder. The conductive pin holder and one end of the control circuit board are sheathed in the holder, the holder has conductive layers on surfaces between the holder and the control circuit board and the conductive pin holder, the other end of the control circuit board has a conductive contact and is sheathed in and contacts the conductive tube assembly. The non-magnetic and conductive pin, the conductive pin holder, the holder, the control circuit board and the conductive tube assembly constitute a conductive path.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1A shows an electromagnetic and capacitive pointer according to one embodiment of the invention.

FIG. 1B is a sectional view of the electromagnetic and capacitive pointer shown in FIG. 1A.

FIG. 1C is an exploded view of the electromagnetic and capacitive pointer shown in FIG. 1A and FIG. 1B.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

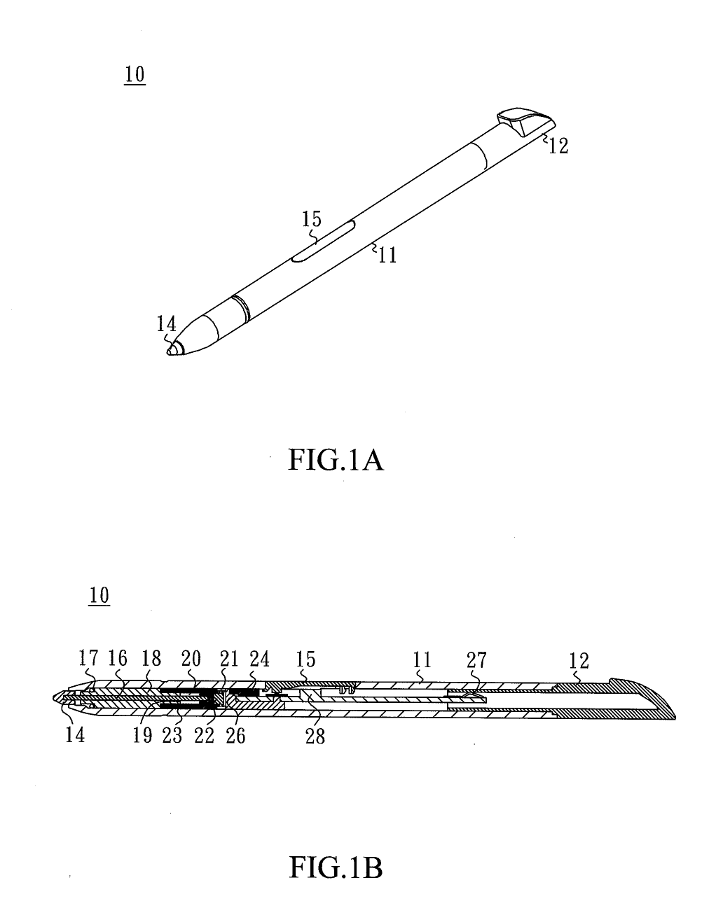

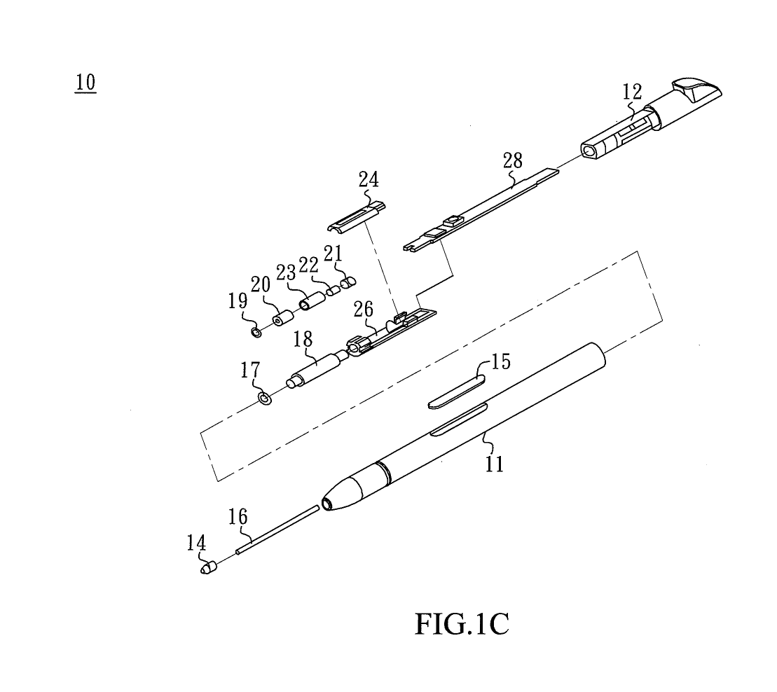

FIG. 1A shows an electromagnetic and capacitive pointer according to one embodiment of the invention. The electromagnetic and capacitive pointer 10 comprises a tube assembly 11, a conductive tube assembly 12, a pen tip 14 and a button 15. The electromagnetic and capacitive pointer 10 of this embodiment will be further described in detail with FIG. 1B and FIG. 1C.

FIG. 1B is a sectional view of the electromagnetic and capacitive pointer shown in FIG. 1A. The electromagnetic and capacitive pointer 10 further comprises an non-magnetic and conductive pin 16 or a conductive pin with a low permeability μ, a first ferrite core 18, a buffer component 19, a second ferrite core 20, a conductive spring 21, a conductive elastomer 22, a conductive pin holder 23, holders 24 and 26, and a control circuit board 28. The control circuit board 28 has a conductive contact 27 or a conductive elastic strip so as to contact the conductive tube assembly 12. An elastomer 17 is located on the first ferrite core 18 and between the first ferrite core 18 and the tube assembly 11.

The tube assembly 11 comprises an non-conductive tube assembly while the conductive tube assembly 12 comprises a tube assembly of conductive material or a tube assembly with inner and outer conductive plated surfaces. The pen tip 14 comprises a rubber pen tip or a conductive pen tip. The non-magnetic and conductive pin 16 comprises a conductive pin of non-magnetic metal materials such as stainless steel. The buffer component 19 is located between the first ferrite core 18 and the second ferrite core 20. The buffer component 19 comprises mylar. The conductive elastomer 22 comprises a conductive rubber. The control circuit board 28 comprises a printed circuit board with a resonance circuit and components thereon so that the electromagnetic and capacitive pointer can resonate with the electromagnetic signals from sensor coils or antennas of a touch panel.

FIG. 1C is an exploded view of the electromagnetic and capacitive pointer shown in FIG. 1A and FIG. 1B. The tube assembly 11 and the conductive tube assembly 12 constitute a hollow assembly to accommodate the non-magnetic and conductive pin 16, the first ferrite core 18, the second ferrite core 20, the conductive spring 21, the conductive pin holder 23, the conductive elastomer 22, the holders 24 and 26, the control circuit board 28. The diameters of the tube assembly 11 and the conductive tube assembly 12 are preferably about 5.5 millimeter, but not limited to 5.5 millimeter.

The first ferrite core 18, the second ferrite core 20 and a coil (not shown) winding the first ferrite core 18 constitute a variable inductor, and the coil electrically connects to the control circuit board 28 through a conductive wire (not shown) to complete a resonance circuit. The first ferrite core 18 and the second ferrite core 20 are hollow and the diameters of the first ferrite core 18 and the second ferrite core 20 are slightly larger than that of the non-magnetic and conductive pin 16 so that the non-magnetic and conductive pin 16 can move through the centers of the first ferrite core 18 and the second ferrite core 20. The inductance can be changed through the relative displacement between the first ferrite core 18 with the winding coil and the second ferrite core 20 by pushing the second ferrite core 20 and the conductive pin holder 23 via the non-magnetic and conductive pin 16.

One end of the non-magnetic and conductive pin 16 contrary to the tip and the second ferrite core 20 are sheathed in the conductive pin holder 23. The conductive elastomer 22 is sheathed in the conductive spring 21 and both are located between the second ferrite core 20 and the control circuit board 28. The conductive pin holder 23 contacts the conductive spring 21. The ends of the second ferrite core 20 and the non-magnetic and conductive pin 16 contrary to the tip and the conductive pin holder 23 are sheathed in the holders 24 and 26. One end of the control circuit board 28 toward the tip is also sheathed in the holders 24 and 26. The contact surfaces between the holder 26 and the control circuit board 28 and between the holder 26 and the conductive pin holder 23 have conductive layers thereon. The contact surfaces between the control circuit board 28 and the holder 26 and between the control circuit board 28 and the conductive spring 21 have electrodes (not shown) thereon. Thus the non-magnetic and conductive pin 16, the conductive pin holder 23, the conductive spring 21, the holder 26, the control circuit board 28 and the conductive tube assembly 12 constitute a conductive path. When an user uses the electromagnetic and capacitive pointer 10 to contact or approach the surface of a touch panel, the user (fingers), the conductive tube assembly 12 and the touch panel constitute a conductive path through the conductive path mentioned above so as to perform input operation.

The electromagnetic and capacitive pointer in one embodiment of the invention has both electromagnetic and user hand held capacitive input functions to meet the requirement of using a pointer on a touch panel with electromagnetic and capacitive input functions.

Although specific embodiments have been illustrated and described, it will be appreciated by those skilled in the art that various modifications may be made without departing from the scope of the present invention, which is intended to be limited solely by the appended claims.

What is claimed is:

1. An electromagnetic and capacitive pointer, comprising:
a tube assembly and a conductive tube assembly;
a first ferrite core and a second ferrite core;
an non-magnetic and conductive pin penetrating through the first ferrite core and the second ferrite core and being moveable through the first ferrite core;
a control circuit board connecting a coil winding the first ferrite core to form a resonance circuit;
a conductive pin holder, the second ferrite core and one end of the non-magnetic and conductive pin being sheathed in the conductive pin holder; and
a holder, the conductive pin holder and one end of the control circuit board being sheathed in the holder, the holder having conductive layers on surfaces between the holder and the control circuit board and the conductive pin holder, the other end of the control circuit board having a conductive contact and being sheathed in and contacting the conductive tube assembly;
wherein the non-magnetic and conductive pin, the conductive pin holder, the holder, the control circuit board and the conductive tube assembly constitute a conductive path.

2. The electromagnetic and capacitive pointer according to claim 1, wherein the conductive tube assembly comprises a tube assembly of conductive material or a tube assembly with inner and outer conductive plated surfaces.

3. The electromagnetic and capacitive pointer according to claim 1, wherein the non-magnetic and conductive pin comprises a conductive pin of non-magnetic metal material.

4. The electromagnetic and capacitive pointer according to claim 1 further comprising a buffer component between the first ferrite core and the second ferrite core.

5. The electromagnetic and capacitive pointer according to claim 1 further comprising a conductive spring and a conductive elastomer, the conductive elastomer being sheathed in the conductive spring and being located in the conductive pin holder and between the second ferrite core and the control circuit board.

6. The electromagnetic and capacitive pointer according to claim 5, wherein the control circuit board has an electrode on the surface between the control circuit board and the conductive spring.

7. The electromagnetic and capacitive pointer according to claim 1, wherein diameters of the tube assembly and the conductive tube assembly are preferably about 5.5 millimeter.

8. The electromagnetic and capacitive pointer according to claim 1 further comprising an elastomer located on the first ferrite core and between the first ferrite core and the tube assembly.

9. The electromagnetic and capacitive pointer according to claim 1, wherein the control circuit board has a conductive contact or a conductive elastic strip so as to contact the conductive tube assembly.

10. The electromagnetic and capacitive pointer according to claim 1, wherein the electromagnetic and capacitive pointer is used on a touch panel.
